(19) United States
(12) Patent Application Publication
(10) Pub. No.: US 2007/0051248 A1
(43) Pub. Date: Mar. 8, 2007

(54) Hot and cold beverage maker

(76) Inventors: Kwok Kay Lee, Hong Kong (CN); Ka Lok Joe Liu, Hong Kong (CN)

Correspondence Address: ALIX YALE & RISTAS LLP, 750 MAIN STREET, SUITE 1400, HARTFORD, CT, 06103, US

(21) Appl. No.: 11/593,366

(22) Filed: Nov. 6, 2006

Related U.S. Application Data
(63) Continuation-in-part of application No. 11/037,606, filed on Jan. 18, 2005.

(51) Int. Cl. A47J 31/047; A23F 3/00; A47J 31/40; B67D 5/62

(52) U.S. Cl. 99/281; 62/392; 99/323.3; 99/287

(57) ABSTRACT

A hot and cold beverage maker has apparatus for preparing a hot beverage and a beverage jug into which the hot beverage is dispensed and cooled. The jug has an outer receptacle having an outer receptacle wall and a base and an inner receptacle for receiving a cooling agent. The inner receptacle is removably located within the outer receptacle and has an inner receptacle wall together with the outer receptacle wall defining a beverage compartment for receiving the hot beverage to be cooled. A rotational paddle is located within the beverage compartment between the inner and outer receptacle walls for stirring a beverage in the beverage compartment. There may also be a rotational blade within the inner receptacle for agitating the cooling agent.

### CONTINUATION DATA

This application is a Continuation-in-part of U.S. patent application Ser. No. 11/037,606 filed Jan. 18, 2005 and published as US 2006-0156754 on 07-20-2006, the entire contents of which are incorporated herein by reference.

### BACKGROUND TO THE INVENTION

1. Field of the Invention

The present invention relates to beverage makers and more particular to hot and cold beverage makers. In particular, the invention relates to an apparatus for making cold or chilled beverages.

2. Description of the Prior Art

Cold beverages like ice coffee, ice tea and ice chocolate are becoming very popular. Making such drinks requires preparation of a hot beverage which is cooled before blending it with ice or pouring it over ice in glass or cup. This procedure requires two machines: a hot beverage maker and a chiller or cooler.

A variety of apparatus are available for chilling beverages. Such apparatus comprise a receptacle into which a hot beverage is placed and a refrigeration unit for cooling the beverage. Such apparatus are designed for commercial use and are not typically suited for domestic purposes. A refrigeration unit is required for cooling the beverage and even a small refrigeration unit is large and creates considerable noise by domestic appliance standards. As an alternative, the hot beverage can be placed in a domestic refrigerator to cool. However, it can take time for a beverage to cool sufficient in this way.

Accordingly, it is an object of the present invention to provide a hot and cold beverage maker that can be used to make both hot beverages and cold beverages, and more particularly to make cold versions of traditionally hot beverages such as ice tea, ice coffee or ice chocolate.

### SUMMARY OF THE INVENTION

In view of the foregoing, there is disclosed herein a hot and cold beverage maker comprising a housing having a base and a body, apparatus in the body for preparing a hot beverage, a beverage jug comprising an outer receptacle having an outer receptacle wall and a base, an inner receptacle for receiving a cooling agent, the inner receptacle removably located within the outer receptacle and having an inner receptacle wall, the inner and outer receptacle walls defining a beverage compartment between them for receiving a hot beverage to be cooled and a rotational paddle located within the beverage compartment between the inner and outer receptacle walls for stirring a beverage in the beverage compartment, and a cradle on the base for supporting the beverage jug for receiving a prepared hot beverage.

Preferably, the apparatus for preparing a hot beverage comprises a brewing chamber for infusion of beverage ingredients in hot water.

Preferably, the apparatus for preparing a hot beverage is a drip-type coffee maker.

Preferably, the paddle comprises a rotational hub in the base of the outer receptacle and a blade extending from the hub into the beverage compartment between the inner and outer receptacle walls.

Preferably, the cradle includes a rotational coupling for engaging the hub when the beverage jug is placed on the cradle.

Preferably, the beverage maker further comprises a motor in the housing for rotating the rotational coupling.

Preferably, the beverage maker further comprises a rotational blade provided within the inner receptacle for agitating the cooling agent.

Preferably, the beverage maker further comprises a rotational blade provided with the inner receptacle for agitating the cooling agent, the blade engaging and rotated by the hub when the inner receptacle is located within the outer receptacle.

Further aspects of the invention will become apparent from the following description.

### BRIEF DESCRIPTION OF THE DRAWINGS

A preferred form of the present invention will now be described by way of example only and with reference to the accompanying drawings, in which:

FIG. 1 is a section schematic view through a hot and cold beverage maker according to the invention,

FIG. 2 is an upper plan section view through the hot and cold beverage maker,

FIG. 3 is a lower plan section view through the hot and cold beverage maker,

FIG. 4 is a section schematic view of a beverage jug of the beverage maker, and

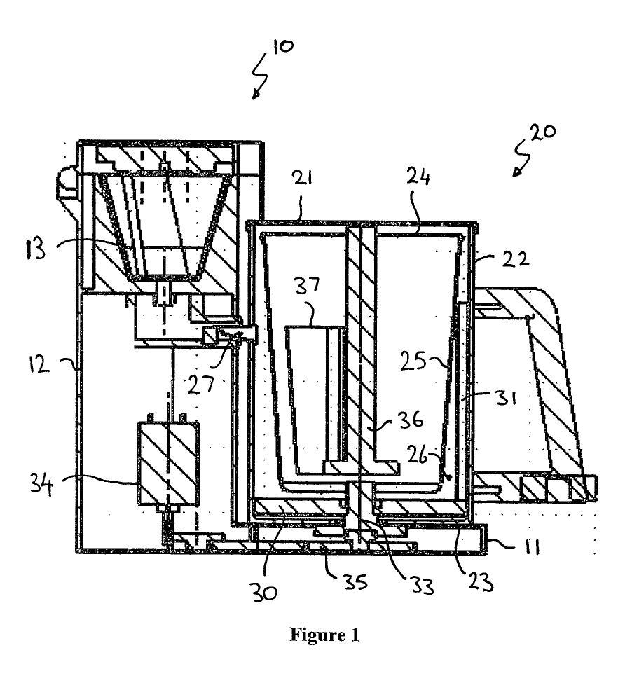

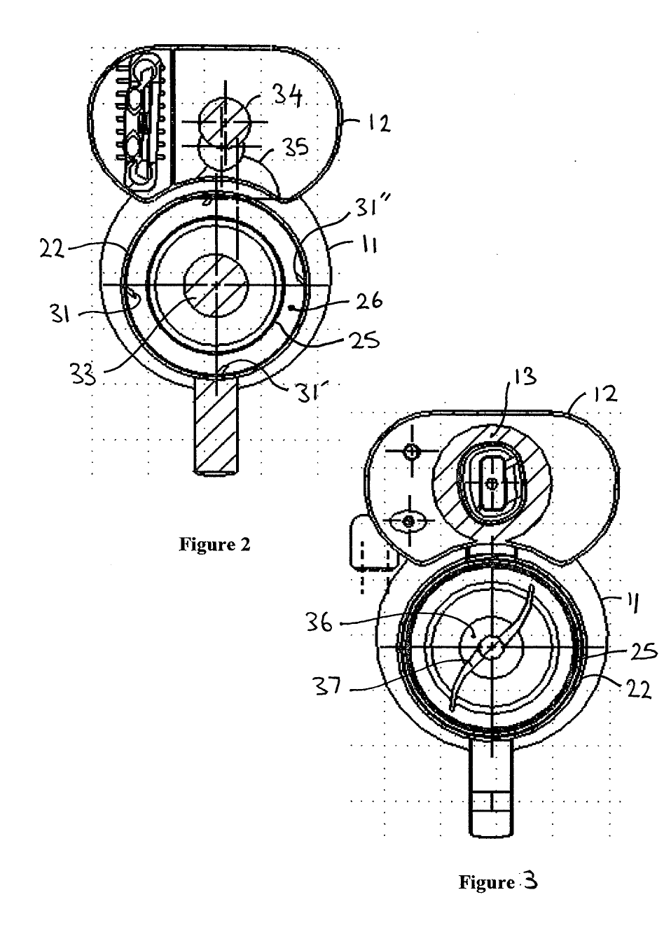

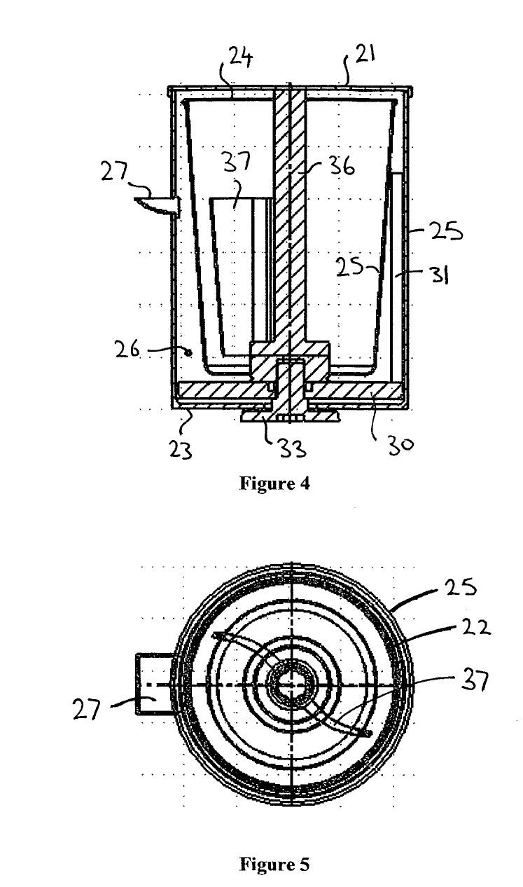

FIG. 3 is a plan section schematic through the beverage jug.

### DETAIL DESCRIPTION OF THE PREFERRED EMBODIMENT

A hot and cold beverage maker according to the invention has apparatus for preparing a hot beverage and a beverage jug into which the hot beverage is dispensed and cooled. The jug has an outer receptacle having an outer receptacle wall and a base, and an inner receptacle for receiving a cooling agent. The inner receptacle is removably located within the outer receptacle and has an inner receptacle wall that together with the outer receptacle wall define a beverage compartment for receiving the hot beverage to be cooled. A rotational paddle is located within the beverage compartment between the inner and outer receptacle walls for stirring a beverage in the beverage compartment. There may also be a rotational blade within the inner receptacle for agitating the cooling agent.

In the drawings there is depicted a preferred embodiment of such a hot and cold beverage maker comprising a housing 10 having a lower base portion 11 for supporting a beverage jug 20 and a vertical body portion 12 extending from the base 11. Within the body portion 12 are a water reservoir, a water heater, a spreader and brew chamber 13. Water is delivered from the reservoir through the water heater, to be heated, and to the spreader for discharge into the brew chamber 13. Within the brew chamber 13 beverage ingredients are infused with the heated water to produce a hot beverage. The hot beverage flows out of the brew chamber 13 and is delivered to the beverage jug 20. The arrangement described thus far is substantially identical to known infusion type coffee makers (also known as ‘filter’ or ‘drip-type’ coffee makers) and its construction is within the capabilities of a person skilled in the art.

The beverage jug 20 comprises a cylindrical outer receptacle 21 having an outer wall 22 preferably made of clear glass or plastic material and a base 23. Removably located within the outer receptacle 21 is an inner receptacle 24 for receiving a cooling agent such as a cooling Gel, rock salt, or ice. The inner receptacle 24 has an outer cylindrical wall 25. An annular shaped beverage chamber 26 is formed between the cylindrical wall 22 of the outer receptacle and the cylindrical wall 25 of the inner receptacle. A spout 27 is provided in the outer receptacle wall 22 for receiving a prepared hot beverage from brew chamber and for dispensing beverage from within the beverage chamber 26. A handle 28 is located on the outside of the jug 20 for handling.

The inner receptacle 3 is made from a heat conductive material such as aluminum or stainless steel for efficient transfer of heat energy between the cooling agent in the inner receptacle 24 and the beverage in the beverage compartment 26. If rock salt is used as the cooling agent then stainless steel is the preferred material for the inner receptacle 24. However, any heat conductive material can be used. The inner receptacle 24 is removable from the outer reciprocal 21 for cleaning and so that it can be recharged with cooling agent. When gel or ice are used as cooling agent the inner reciprocal 24 can be stored containing the cooling agent in a refrigerator prior to use. Additionally, the inner receptacle 24 can be removed simply to use the device to prepare a hot beverage for consumption hot without chilling.

A paddle is located within the beverage compartment 26 for stirring the hot beverage to aid cooling. The paddle comprises a rotational hub 30 in the outer receptacle base 23 and a blade 31 extending upwardly from the periphery of the hub 30 into the beverage compartment 26 between the inner and outer receptacle walls 22, 25. The base 11 of the housing is provided with a cradle for receiving the jug 20. The cradle has a coupling mounted on a rotational spindle 33 that engages with the jug hub 30 when the jug 20 is placed in the cradle. A motor 34 is located within the body 12 and drives a belt 35 to rotate the spindle 33 when the motor is operated. When the jug 20 is in the cradle of the device beverages in the jug 20 can be stirred by activation of the motor 34.

A second rotational spindle 36 extends into inner receptacle 24 from the hub. A blade 37 extends radially from the spindle 36 and is caused to rotate with the hub. The inner receptacle blade 37 agitates the cooling agent. This agitation improves the cooling effect of salt or ice cooling agents. Provision of blades 37 within a removable receptacle 36 can be achieved in such known manner as in drink blenders and the like.

The above hot and cold beverage maker can be used to make both hot beverages such as tea, coffee and chocolate. The beverages can then be cooled within the beverage jug for making cold beverages such as ice tea, ice coffee and ice chocolate.

It should be appreciated that modifications and/or alternations obvious to those skilled in the art are not to be considered as beyond the scope of the present invention. For example, in the described embodiment the apparatus in the body for preparing a hot beverage is an infusion type coffee maker. This is not however intended to limit the scope of use or functionality of the invention. It is envisaged that the apparatus could be any hot beverage apparatus such as one for making espresso coffee, tea, hot chocolate or any other hot beverage. Accordingly the apparatus in the body for preparing a hot beverage may include, for example, a pump for pumping pressurized heated water and/or a portafilter, or interchangeable filters or filter holders or any other similar device.

What is claimed is:

1. A hot and cold beverage maker comprising
a housing having a base and a body,
apparatus in the body for preparing a hot beverage,
a beverage jug comprising an outer receptacle having an outer receptacle wall and a base, an inner receptacle for receiving a cooling agent, the inner receptacle removably located within the outer receptacle and having an inner receptacle wall, the inner and outer receptacle walls defining a beverage compartment between them for receiving a hot beverage to be cooled and a rotational paddle located within the beverage compartment between the inner and outer receptacle walls for stirring a beverage in the beverage compartment, and
a cradle on the base for supporting the beverage jug for receiving a prepared hot beverage.

2. The beverage maker of claim 1 wherein the apparatus for preparing a hot beverage comprises a brewing chamber for infusion of beverage ingredients in hot water.

3. The beverage maker of claim 1 wherein the apparatus for preparing a hot beverage is a drip-type coffee maker.

4. The beverage maker of claim 1 wherein the paddle comprises a rotational hub in the base of the outer receptacle and a blade extending from the hub into the beverage compartment between the inner and outer receptacle walls.

5. The beverage maker of claim 4 wherein the cradle includes a rotational coupling for engaging the hub when the beverage jug is placed on the cradle.

6. The beverage maker of claim 5 further comprising a motor in the base for rotating the rotational coupling.

7. The beverage maker of claim 1 further including a rotational blade located within the inner receptacle for agitating the cooling agent.

8. The beverage maker of claim 1 further including a rotational blade located within the inner receptacle for agitating the cooling agent, the blade engaging and rotated by the hub when the inner receptacle is located within the outer receptacle.
